(19) United States
(12) Patent Application Publication
(10) Pub. No.: US 2015/0188900 A1
(43) Pub. Date: Jul. 2, 2015

(54) SESSION MANAGMENT IN A MULTI-TENANT, MULTI-DATA CENTER ENVIRONMENT SYSTEM AND METHOD

(71) Applicant: Digital River, Inc., Minnetonka, MN (US)

(72) Inventors: Daniel John CHARBONNEAU, Chanhassen, MN (US); Keith A. KESTER, Waconia, MN (US)

(21) Appl. No.: 14/588,026

(22) Filed: Dec. 31, 2014

Related U.S. Application Data
(60) Provisional application No. 61/922,280, filed on Dec. 31, 2013.

(51) Int. Cl. H04L 29/06; G06F 9/54

(52) U.S. Cl. CPC H04L 63/08; G06F 9/54

(57) ABSTRACT

A system and method for session management across multiple servers in multiple data centers is disclosed. In this system, API transactions are received from a client system at an API gateway. The gateway is employed to authenticate incoming traffic based on a previously provided key and to route the traffic to a data center that is local to the user. The data center uses transaction-related properties to create and encrypt a token. The token is then passed between the systems thereafter identifying the data center comprising the session.

This application claims the benefit of U.S. Provisional Patent Application No. 61/922,280 filed on 31 Dec. 2013, titled “Session Management in a Multi-Tenant, Multi-Data Center Environment System and Method,” and which application is incorporated herein by reference. A claim of priority is made.

### FIELD OF THE INVENTION

The present disclosure relates generally to the use of application programming interfaces. More particularly, the present disclosure relates to the use of application programming interfaces in complex integration environments for multi-tenant, multi-data center applications.

### BACKGROUND OF THE INVENTION

Historically, the preferred way to deliver web services is through HTTP, which typically means browsers communicating with web servers. However, the stateless nature of HTTP requires the use of some method for identifying the actions of a particular user in a particular user session. Web based companies have used the concept of session IDs as a way to maintain session, using primarily three methods: (1) session id information embedded in the URL, which is received by the application through HTTP GET requests when the user clicks on links embedded in a page, (2) session id information stored within the fields of a form and submitted to the application (e.g. a hidden field submitted with the HTTP POST command), or (3) using cookies. There are many drawbacks to these methods, particular in the area of security. Session ids may be hacked fairly easily, cookies may be deleted.

Traditionally, e-commerce communications from a user shopping on a merchant web site involves the browser calling the e-commerce system directly. This works for sites that are hosted by the e-commerce provider. The e-commerce system drops cookies on the browser, telling the requests how to route. As e-commerce providers turned to the use of web APIs, such as RESTful APIs, a cookieless solution is required. API gateways have been used to create tokens for session management. A token may be stored in a data base so that the session may be recognized with each request. Problems arise when more than one gateway is used and synchronization is required. If the system has more than one gateway that routes all requests, the multiple gateways require synchronization, which adds a lot of complexity.

Prior session management solutions have not addressed the special issues of an application with multiple data center locations. A global e-commerce provider may have multiple data center locations located anywhere in the world. In addition, the client and user can both be located anywhere in the world. An application located in multiple locations provides an added complexity to the situation. A global e-commerce application, for example, may support world-wide commerce by locating data centers throughout the world. Session management in this multi-tenant, multi data center environment is challenging, particularly when all servers are active at all times. The present disclosure provides a solution to these needs and other problems, and offers other advantages over the prior art.

### BRIEF SUMMARY

E-commerce providers may offer a wide variety of services to online merchants and distributors. The global nature of e-commerce services may require multiple data centers with multiple servers located throughout the world. This system and method allows formerly web-page driven transactions to be API driven instead. APIs may be added to access e-commerce systems without making changes in the e-commerce system itself. This allows the merchant/client to host their own web pages and use APIs to connect to the backend commerce system. Of particular importance is the use of the solution in multi-data center environments, such as those used by a global e-commerce system. To maintain performance, load balancing and local features, the system may have data centers distributed throughout the world. When a user shops a client store, the transactions should be sent to the data center local to the user, regardless of where in the world the client store is located.

An API gateway is employed to authenticate incoming traffic based on a previously provided key (usually created from the client id and the site id—a client may have several sites) and to route API traffic to the appropriate data center. When the authenticated transactions reach the appropriate data center, a token is created from various transaction-related properties, including the key, currency, and locale, and possibly other properties including the cookie identifier. The token is encrypted for enhanced security. The token is then passed between the systems thereafter identifying the appropriate data center comprising the session.

Additional advantages and features of the disclosed system and method will be set forth in part in the description which follows, and in part, will become apparent to those skilled in the art upon examination of the following or may be learned by practice of the system and method disclosed.

### BRIEF DESCRIPTION OF THE DRAWINGS

FIG. 1 provides a context diagram showing the use of a session management system and method in practice.

FIG. 2 is an abstract illustration of the client and server side components.

FIG. 3 further illustrates the domain, gateway and services providing a session management system and method.

FIG. 4 illustrates the inner components of an API gateway applying policies and rules related to access of e-commerce services and session tracking in a multi-tenant, multi-data center environment.

FIG. 5 is a flow chart illustrating the session management method.

### DETAILED DESCRIPTION

A system and method for managing user sessions in a multi-tenant, multi-data center environment is disclosed. A user session is generally understood to be the period of time that a user with a unique IP address interacts with an application. For the purpose of the disclosed embodiments, a “session” will also include the activities performed by the user during that period of time. A multi-tenant environment is one in which there are numerous users accessing an application through numerous client websites over a communication network such as the internet, each using the same API set to do so. A multi-data center environment is one in which multiple data centers exist for an application, each data center consisting of multiple servers, each with memory storing modules containing program code which when executed by the server's processor performs the functionality of the application. The data centers may be identical versions of the application and may be located throughout the world. In one embodiment, the multi-tenant, multi-data center environment comprises numerous shopping websites (merchants/clients) through which users perform shopping behaviors and transactions against an e-commerce application system. A session management system and method provides an accurate and efficient means for maintaining internet communication session connections in a multi-tenant, multi-data center environment using APIs.

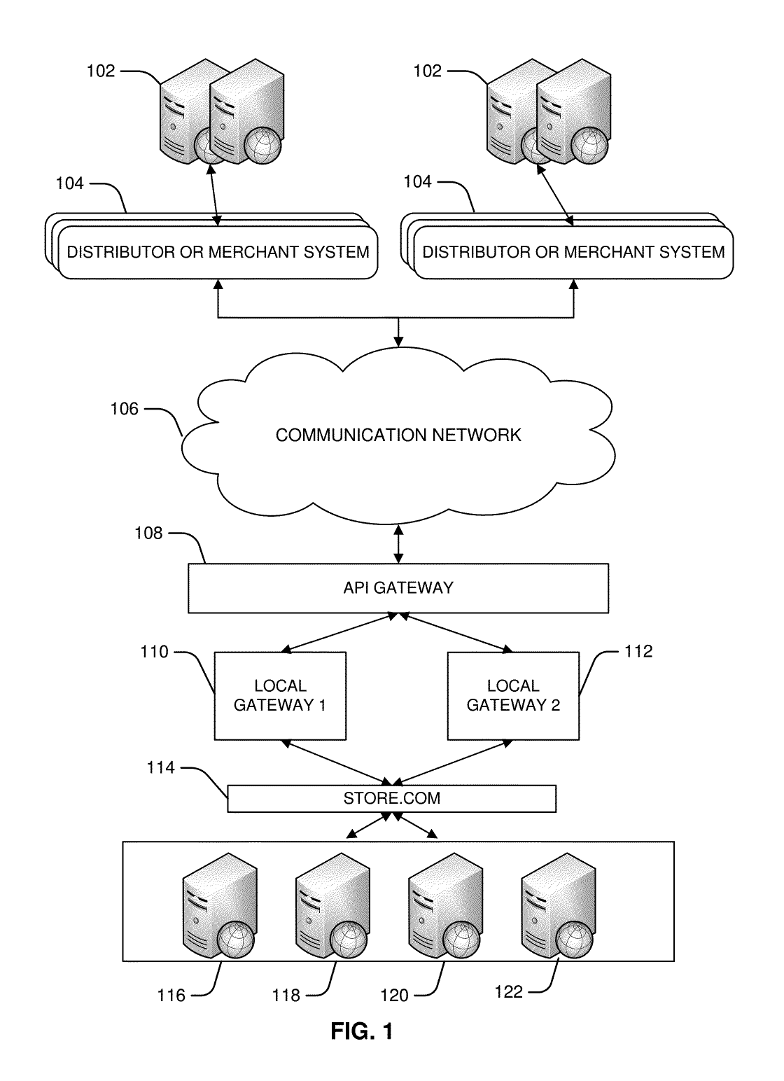

Referring to FIG. 1, internet merchants and product distributors 104, referred to collectively here as merchants or clients of the e-commerce system, often wish to contract with an e-commerce provider for e-store functionality. The merchant sites may or may not be hosted by the e-commerce system. An e-commerce system 108 may provide its services as a module- or product-based system in a client-server configuration, allowing merchants (clients) to access any or all functionality required to implement online sales (server), from product catalog to shopping cart to payments to fulfillment. Responses to client requests are generally served from a collection of servers located in a data center 118. Each data center 118 may be a copy of the entire e-commerce backend and related services. Within a particular data center 118, servers may be staggered for use at any particular time, or they may all be “up,” or active, at any time. The benefits of the disclosed system and method are particularly evident in an environment where the servers are active continuously.

In a web environment, communications between a merchant web site and an e-commerce system may mean accessing a multi-data center system coincident with thousands of others making similar requests. As was discussed above, session management in a web environment was previously maintained using techniques, such as cookies, to carry information identifying the calling device and transaction in order to maintain continuity of transactions. However, when the merchant uses APIs to access back end e-commerce system processes, a different solution is required. Use of multiple data centers 118 with multiple active servers per data center 118 adds additional complexity to these communications.

The use of APIs offer various benefits over cookies and redirection techniques, including enhanced security; the ability for web sites outside of the e-commerce system's own network to access the e-commerce back end functionality; the ability to build separate applications that support the system's functionality such as reviewing order history, using merchandizing features, and searching for products; and the ability to tap into individual or global modules, to name a few. Multiple data centers allow an application to distribute its transactions/traffic in a way that most efficiently addresses the needs of both the application system and the user.

Referring again to FIG. 1, a user 102 may navigate to an online shopping site 104 to browse or purchase. The user may request services such as viewing a product or putting an item in a shopping cart. Web site management tracks the user behavior or activity using a cookie. However, in one embodiment, the distributor or merchant (i.e. client) may send the request in the form of an API to the e-commerce system. The use of APIs to access back end e-commerce services requires that an API be sent over a network 106 to the e-commerce system 108 through an API gateway 110. An API gateway will be understood by those of ordinary skill in the art as a programmable computing device comprised of modules providing services related to the flow of communications to and from an application. Such services may include API development, management and deployment, security and regulatory compliance, load balancing, distribution of traffic among servers, authentication, validation, authorization and audit services as well as routing, orchestration, mediation and other operational governance policies. The gateway exposes an endpoint, which maps to an origin service endpoint. The gateway provides authentication and verification of the requestor and applies distribution rules, policies and custom logic to the incoming message that directs the message to one of the local gateways 112, 114, which may be physically located in various parts of the world.

In another embodiment, the browser may call directly to the gateway with cookies comprising the API key. Authentication and validation are performed. If the API key is valid, the gateway sends the request to the data center depending on geolocation. The data center creates the session and returns the token with the key and the session id and domain encrypted. From then on, all calls to that come in from the user have the key, which is decrypted and validated by the gateway, and are routed to the appropriate data center.

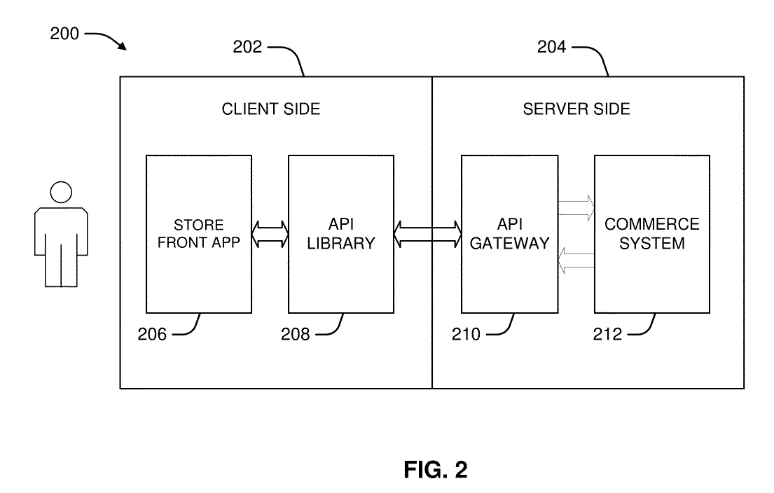

FIG. 2 illustrates the client-server system architecture in a very basic sense. A client (i.e. merchant or distributor) 202 may host a client application consisting of, at a minimum, a storefront application 204 and an API library 206. The API library may contain a set of standard APIs that facilitate the purchasing process for online shoppers. On the server side 208, the e-commerce service may comprise, at a minimum, an API gateway/management component 210 and a commerce services system component 212. The API gateway/management component may contain the standard API definition along with logic and policy used to direct API processes. It is following direction by this component, to local gateway and data center, that the token is created.

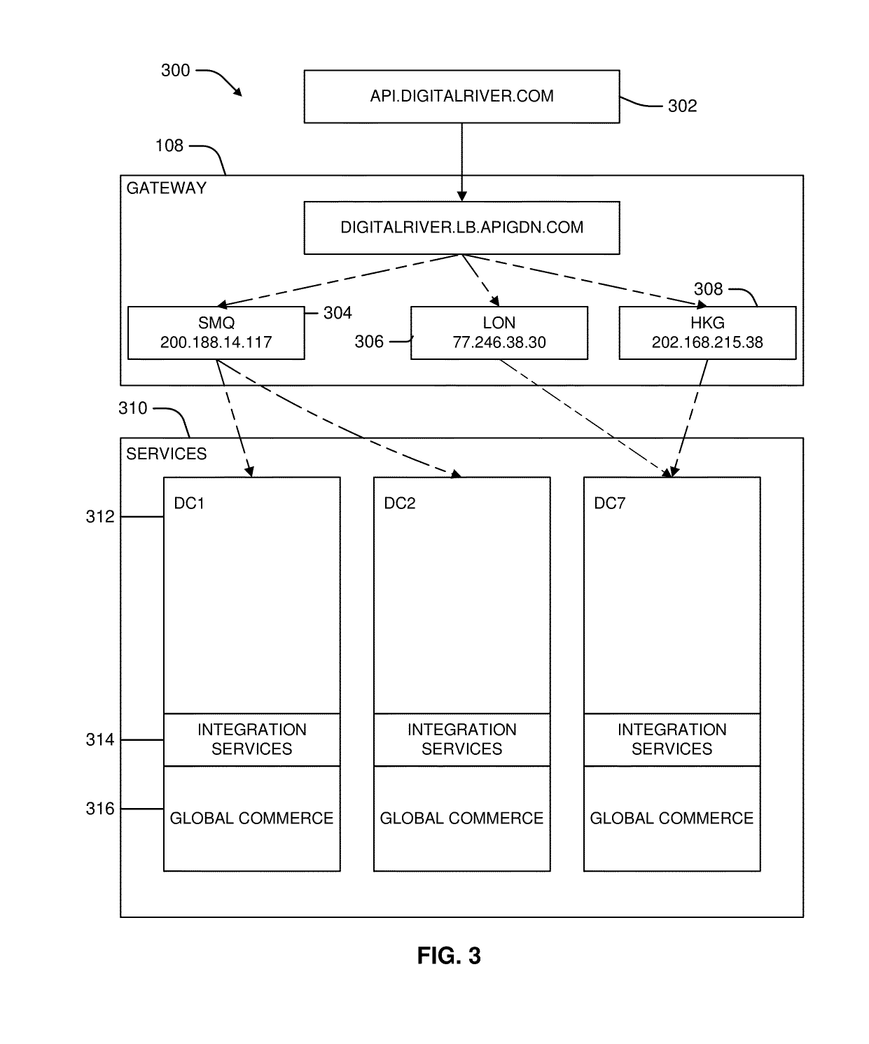

FIG. 3 illustrates the gateway and backend components in more detail 300. This block diagram shows the domain name 302 to which APIs are directed when communicating with the commerce system. Behind this domain is the gateway 108, which may use a product such as that created by Apigee, in which is embedded logic and processes for directing a message to a particular locality (local gateway) 304, 306, 308. In this case, there are three localities (Brazil, London and Hong Kong). Each locality may access services 310 of any of the available data centers 312 which house the integration 316 and global commerce 316 services, depending on need.

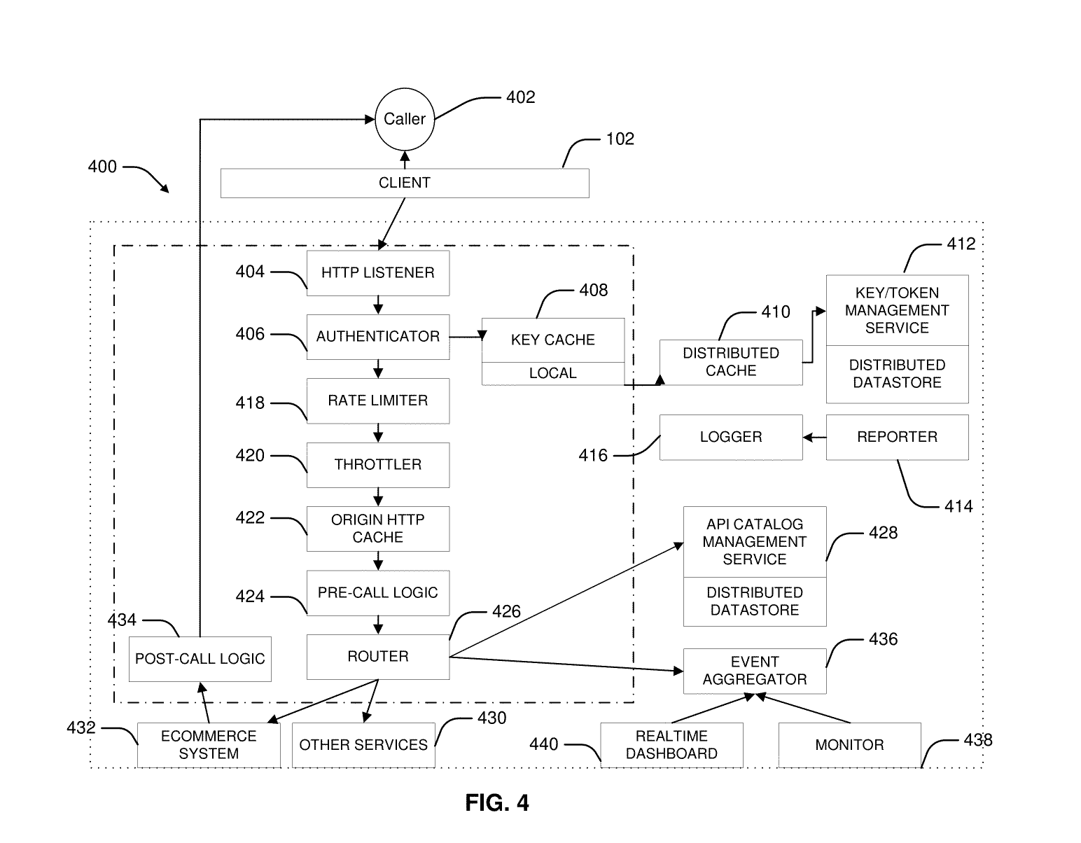

FIG. 4 illustrates the gateway 108, its related services and control features, and its connections to other modules. The caller/user accesses 402 the merchant/client web system 102, which sends the first API to the gateway. The gateway provides various control and authentication features through modules, including the HTTP listener 404 to control web traffic; the authenticator 406 with its key management modules (Key/token management service 412 and its data store and cache modules 408 and 410); rate limiter 418; throttler 420; origin HTTP cache 422; pre-call logic module 424; router 426 including API catalog management service 428 and event aggregator 436 with monitor 438 and dashboard 440 and to observe traffic and fix errors. Other services 430 related to the e-commerce system may be provided. The router 426 may determine the location of the caller (the user, through the client) and route the call to the nearest data center location 112, 114. For example, a user in Brussels shopping a US web site might be routed to a data center located in London. This is also illustrated in FIG. 3. Here, the API call enters the gateway where it is authenticated and the location of the user determined. The location of the user and data contained in the API determine the data center 118 to which the user will be routed. Once in the appropriate data center 118, a token is created for the session. The token comprises values for significant properties for the session. For example, for an e-commerce system, significant properties may include a token id, the cookies from the associated web transaction, the shopper domain, cart-id, shopper id, and a key/currency/locale combination, where the key is the site id and the company or client id from the calling website. All or part of the token values are encrypted for added security. The encrypted value is carried through the user's session to maintain continuity. Post-call logic 434 may be applied to the response prior to sending it back to the caller.

Because the token knows the cookie values and vice versa, communications may switch from cookies (session management for web transactions) to token (session management for API transactions) to cookies (returning web transactions). Both token and cookie have the ability to establish a session. Having both allows the communication to sync back and forth between the token and the cookie using the cookie with the web offering, passing the token identifier and information to the cookie and accessing the backend system with an API (token) versus going through a web browser. This allows the use of front end technologies with the cookie, and backend technologies with the token, and allows the developer to combine disparate technologies.

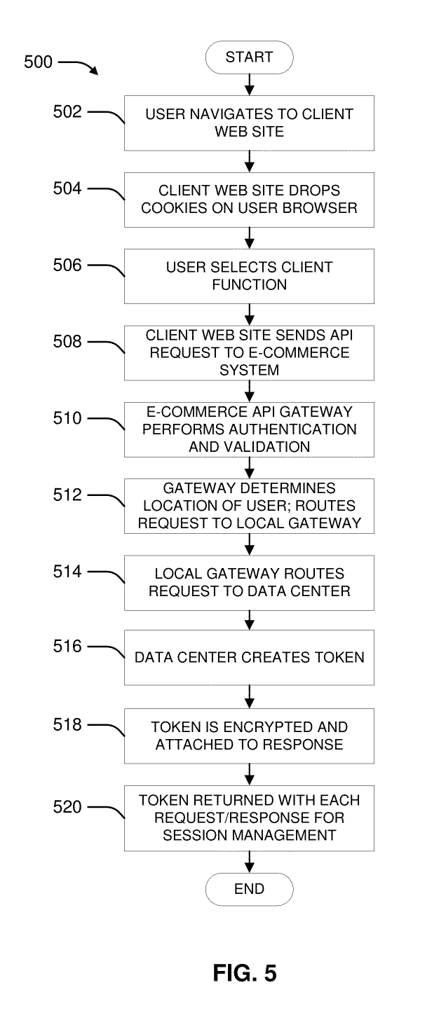

The method is illustrated in FIG. 5. A user navigates to a client site 502, where cookies are installed on the user's browser the first time it accesses the client web site 504. When the user creates a request-producing action on the client site 506, the client sends its first request to the e-commerce system using the API, it sends a previously provided security key 508. The gateway receives the request and performs authentication and validation of the key and client 510. The gateway determines where the user is located and routes the user to the appropriate local gateway 512. The local gateway routes the user to a data center 514. A token is created at the data center using significant attributes for the transaction 516. The token is encrypted for security and attached to the API transaction 518 and returned with each additional message 520. Knowledge of the token by the client is not required.

As was mentioned above, the token may comprise various properties that facilitate the user's transactions. Information related to the session may be included, such as the e-commerce system token identifier, the web session cookie, a shopper domain, cart id, shopper id, currency, locale, and the client key which may be further comprised of the site id and a company id.

Referring again to FIG. 1, a user shopping on a merchant site may either shop anonymously or sign into an established account. A user session is created on the client 102 side and cookies are applied to the browser. As the shopper requests resources, such as a product catalog, the client sends an API to the e-commerce system API gateway which is routed to a data center 116-122. An access token is created at this point. If the shopper has not logged in, a limited access token is created for anonymous shopping. If the user sends login credentials (O auth) a full access token is created for authenticated shopping. The API gateway contains policies and rules for managing operations among the local gateways and the multi-data center e-commerce environment. The token may be passed to the store site 104 where the cookie is created that will maintain consistency among transactions as the back end system is accessed. This is especially important in a multi-tenant, multi-data center environment where multiple active servers are available at all times. Store.com 114, the e-commerce system host domain, creates the cookie which maintains continuity between the store.com URL and the data center/server where the services are located.

The environment in which a session management system and method operates is necessarily composed of a number of electronic components. E-commerce systems are hosted on servers located in data centers that are accessed by networked (e.g. internet) users through a web browser on a remote computing device and an API request created by the client website. One of ordinary skill in the art will recognize that a “host” is a computing system that is accessed by a user, usually over cable or phone lines, while the user is working at a remote location. The system that contains the data and functionality is the host, while the computing system at which the user sits is the remote system. Software modules may be referred to as being “hosted” by a server. In other words, the modules are stored in memory in the system for execution by a processor. The various components of an e-commerce service provider include modules performing catalog, merchandising, shopping cart, pricing, payments, tax, and fulfillment, among others. The e-commerce application may further comprise application interfaces, application programming interfaces (APIs), a commerce engine, services, third party services and solutions, and client and partner integrations. The application interfaces may include tools that are presented to a user for use in implementing and administering online stores and their functions, including, but not limited to, store building and set up, merchandising and product catalog (user is a store administrator or online merchant), or for purchasing items from an online store (user is a shopper). For example, users may access the client website from a computer workstation or server, a desktop or laptop computer, or a mobile device. The client may then access the e-commerce system using APIs, which provide communications from the client's web servers to the e-commerce system data center application servers. A commerce engine comprises a number of components required for online shopping, for example, modules with instructions stored in memory that when executed by the processor perform functions related to customer accounts, orders, catalog, merchandizing, subscriptions, tax, payments, fraud, administration and reporting, credit processing, inventory and fulfillment. Services support the commerce engine and comprise one or more of the following: fraud, payments, and enterprise foundation services (social stream, wish list, saved cart, entity, security, throttle and more). Third party services and solutions may be contracted with to provide specific services, such as address validation, payment providers, tax and financials. Client integrations may include fulfillment partners, client fulfillment systems, and warehouse and logistics providers.

As is well known in the art, an electronic computing device, such as a server, laptop, tablet computer, smartphone, or other mobile computing device typically includes, among other things, a processor (central processing unit, or CPU), memory, a graphics chip, a secondary storage device, input and output devices, and possibly a display device, all of which may be interconnected using a system bus. Input and output may be manually performed on a sub-component of the computer or device system such as a keyboard or disk drive, but may also be electronic communications between devices connected by a network, such as a wide area network (e.g. the Internet) or a local area network. The memory may include random access memory (RAM) or similar types of memory. Software applications stored in the memory or secondary storage for execution by a processor are operatively configured to perform the operations in one embodiment of the system. The software applications may correspond with a single module or any number of modules. Modules of a computer system may be made from hardware, software, or a combination of the two. Generally, software modules are program code or instructions for controlling a computer processor to perform a particular method to implement the features or operations of the system. The modules may also be implemented using program products or a combination of software and specialized hardware components. In addition, the modules may be executed on multiple processors for processing a large number of transactions, if necessary or desired.

A secondary storage device may include a hard disk drive, floppy disk drive, CD-ROM drive, DVD-ROM drive, or other types of non-volatile data storage, and may correspond with the various equipment and modules shown in the figures. The processor may execute the software applications or programs either stored in memory or secondary storage or received from the Internet or other network. The input device may include any device for entering information into computer, such as a keyboard, joy-stick, cursor-control device, or touch screen. The display device may include any type of device for presenting visual information such as, for example, a computer monitor or flat-screen display. In the context of the presently described invention, the output device may include any type of device used to provide information in machine-readable form. Although the computer, computing device or server has been described with various components, it should be noted that such a computer, computing device or server can contain additional or different components and configurations.

It is to be understood that even though numerous characteristics and advantages of various embodiments of the present invention have been set forth in the foregoing description, together with details of the structure and function of various embodiments, this disclosure is illustrative only, and changes may be made in detail, especially in matters of structure and arrangement of parts within the principles of the present invention to the full extent indicated by the broad general meaning of the terms in which the appended claims are expressed. For example, the particular properties of a token may vary depending on the particular application, while maintaining substantially the same functionality without departing from the scope and spirit of the present invention.

1. A network-based session management system in which a plurality of users access a plurality of client web stores, which access web services located in a plurality of data centers, each with a plurality of servers, comprising:
a user authentication module for identifying the user and client;
a routing module operatively configured to determine which of a plurality of disparately located data centers the authenticated user transactions are sent;
a token management module operatively configured to (i) create a token based on information provided by the user and client, and (2) apply the token to the API response such that each individual communication between the user and the data center contains the token in order to maintain session.

2. A method for maintaining session in a multi-tenant, multi-data center environment, comprising:
receiving an API request identifying user attributes and a client security key;
performing authentication and validation on the client and the user;
routing the request to a geographically appropriate data center based on the user attributes;
creating a token at the data center using significant attributes for the transaction;
encrypting the token;
attaching the token to the session such that the token is returned with each subsequent request.
